(19) United States
(12) Patent Application Publication
(10) Pub. No.: US 2025/0105965 A1
(43) Pub. Date: Mar. 27, 2025

(54) REFERENCE SIGNAL CONFIGURATION

(71) Applicant: Nokia Technologies Oy, Espoo (FI)

(72) Inventors: Sahan Damith LIYANAARACHCHI, Lempäälä (FI); Traian ABRUDAN, Espoo (FI); Mario COSTA, Espoo (FI); Mikko SÄILY, Laukkoski (FI); Muhammad Ikram ASHRAF, Espoo (FI)

(21) Appl. No.: 18/897,653

(22) Filed: Sep. 26, 2024

(30) Foreign Application Priority Data
Sep. 27, 2023 (FI) 20236064

(51) Int. Cl. H04L 5/00

(52) U.S. Cl. CPC H04L 5/0048

(57) ABSTRACT

According to an example aspect of the present invention, there is provided a method comprising receiving or transmitting at least one reference signal, wherein the at least one reference signal is transmitted according to a reference signal configuration, and wherein the reference signal configuration indicates a power-muting for at least one inner resource block of a plurality of resource blocks assigned in the frequency-domain to the at least one reference signal, and a power-boosting for at least two edge resource blocks of the plurality of resource blocks.

### FIELD

Various example embodiments relate in general to cellular communication networks and more specifically, to reference signal configuration in such networks.

### BACKGROUND

Reference signals are very important in various cellular communication networks, such as in cellular communication networks operating according to 5G radio access technology. 5G radio access technology may also be referred to as new radio, NR, access technology. 3rd generation partnership project, 3GPP, develops standards for 5G/NR and some topics in the 3GPP discussions are related to reference signals, which are usable for estimating a position and/or a velocity of a target. There is a need to provide improved methods, apparatuses and computer programs related to reference signal configurations. Such improvements may be exploited in other cellular communication networks as well, like in 6G networks.

### SUMMARY

According to some aspects, there is provided the subject-matter of the independent claims. Some example embodiments are defined in the dependent claims.

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first aspect of the present invention, there is provided an apparatus comprising at least one processor and at least one memory storing instructions that, when executed by the at least one processor, cause the apparatus at least to receive or transmit at least one reference signal, wherein the at least one reference signal is transmitted according to a reference signal configuration, and wherein the reference signal configuration indicates a power-muting for at least one inner resource block of a plurality of resource blocks assigned in the frequency-domain to the at least one reference signal, and a power-boosting for at least two edge resource blocks of the plurality of resource blocks.

Example embodiments of the first aspect may comprise at least one feature from the following bulleted list or any combination of the following features:
wherein the stored instructions further cause, when executed by the at least one processor, the apparatus at least to receive the at least one reference signal from a wireless network node and determine the reference signal configuration based on the at least one received reference signal;
wherein the stored instructions further cause, when executed by the at least one processor, the apparatus at least to receive the reference signal configuration from a wireless network node;
wherein the at least one reference signal is a positioning reference signal;
wherein the stored instructions further cause, when executed by the at least one processor, the apparatus at least to estimate a position and/or a velocity of the apparatus based on the at least one reference signal;
wherein the stored instructions further cause, when executed by the at least one processor, the apparatus at least to receive the reference signal configuration from a wireless network node and transmit the at least one reference signal according to the received reference signal configuration;
wherein the stored instructions further cause, when executed by the at least one processor, the apparatus at least to determine the reference signal configuration based on a muting pattern received from a wireless network node and a capability of the apparatus and transmit the at least one reference signal according to the determined reference signal configuration;
wherein the at least one reference signal is a sounding reference signal;
wherein the stored instructions further cause, when executed by the at least one processor, the apparatus at least to determine a number of the at least one inner resource block and determine the power-boosting for the at least two edge resource blocks based on the number of the at least one inner resource block;
wherein the resource blocks are physical resource blocks;
wherein the power-muting comprises full muting or partial muting of the at least one inner resource block.

According to a second aspect of the present invention, there is provided an apparatus comprising at least one processor and at least one memory storing instructions that, when executed by the at least one processor, cause the apparatus at least to determine a reference signal configuration for at least one reference signal to be received or transmitted by a user equipment, wherein the reference signal configuration indicates a power-muting of at least one inner resource block of a plurality of resource blocks assigned in the frequency-domain to the at least one reference signal, and a power-boosting of at least two edge resource blocks of the plurality of resource blocks, and transmit the reference signal configuration.

Example embodiments of the second aspect may comprise at least one feature from the following bulleted list or any combination of the following features:
wherein the stored instructions further cause, when executed by the at least one processor, the apparatus at least to determine a number of the at least one inner resource block based on a required trade-off between range detection and velocity detection of the user equipment.

According to a third aspect of the present invention, there is provided a first method, comprising receiving or transmitting at least one reference signal, wherein the at least one reference signal is transmitted according to a reference signal configuration, and wherein the reference signal configuration indicates a power-muting for at least one inner resource block of a plurality of resource blocks assigned in the frequency-domain to the at least one reference signal, and a power-boosting for at least two edge resource blocks of the plurality of resource blocks.

According to a fourth aspect of the present invention, there is provided a second method, comprising determining a reference signal configuration for at least one reference signal to be received or transmitted by a user equipment, wherein the reference signal configuration indicates a power-muting of at least one inner resource block of a plurality of resource blocks assigned in the frequency-domain to the at least one reference signal, and a power-boosting of at least two edge resource blocks of the plurality of resource blocks and transmitting the reference signal configuration.

According to a fifth aspect of the present invention, there is provided an apparatus, comprising means for receiving or transmitting at least one reference signal, wherein the at least one reference signal is transmitted according to a reference signal configuration, and wherein the reference signal configuration indicates a power-muting for at least one inner resource block of a plurality of resource blocks assigned in the frequency-domain to the at least one reference signal, and a power-boosting for at least two edge resource blocks of the plurality of resource blocks.

According to a sixth aspect of the present invention, there is provided an apparatus, comprising means for determining a reference signal configuration for at least one reference signal to be received or transmitted by a user equipment, wherein the reference signal configuration indicates a power-muting of at least one inner resource block of a plurality of resource blocks assigned in the frequency-domain to the at least one reference signal, and a power-boosting of at least two edge resource blocks of the plurality of resource blocks and means for transmitting the reference signal configuration.

According to a seventh aspect of the present invention, there is provided a non-transitory computer readable medium having stored thereon a set of computer readable instructions that, when executed by at least one processor, cause an apparatus to at least perform the first method. According to an eighth aspect of the present invention, there is provided a non-transitory computer readable medium having stored thereon a set of computer readable instructions that, when executed by at least one processor, cause an apparatus to at least perform the second method.

According to a ninth aspect of the present invention, there is provided a computer program comprising instructions which, when the program is executed by an apparatus, cause the apparatus to carry out the first method. According to a tenth aspect of the present invention, there is provided a computer program comprising instructions which, when the program is executed by an apparatus, cause the apparatus to carry out the second method.

### BRIEF DESCRIPTION OF THE DRAWINGS

FIG. 1 illustrates an example of a network scenario in accordance with at least some example embodiments;

FIG. 2 illustrates a first signalling graph in accordance with at least some example embodiments;

FIG. 3 illustrates a second signalling graph in accordance with at least some example embodiments;

FIG. 4 illustrates a resource block in accordance with at least some example embodiments;

FIG. 5 illustrates frequency muting in accordance with at least some example embodiments;

FIG. 6 illustrates an example apparatus capable of supporting at least some example embodiments;

FIG. 7 illustrates a flow graph of a first method in accordance with at least some example embodiments;

FIG. 8 illustrates a flow graph of a second method in accordance with at least some example embodiments.

### EXAMPLE EMBODIMENTS

Embodiments of the present disclosure provide improvements for estimating a position and/or velocity of a target, such as a User Equipment, UE, in a cellular communication network. More specifically, estimation of the position and/or velocity of the target may be improved by exploiting a reference signal configuration, wherein at least one inner resource block of a plurality of resource blocks assigned in the frequency-domain to at least one reference signal is muted. At least two edge resources may then be power-boosted to enable better estimation of the velocity of the target. Indeed, power-muting of inner resource blocks and power-boosting of edge resource blocks may be particularly beneficial for velocity estimation. The at least one reference signal may be for example a Positioning Reference Signal, PRS, in case of UE-based estimation or a Sounding Reference Signal, SRS, in case of network-based estimation.

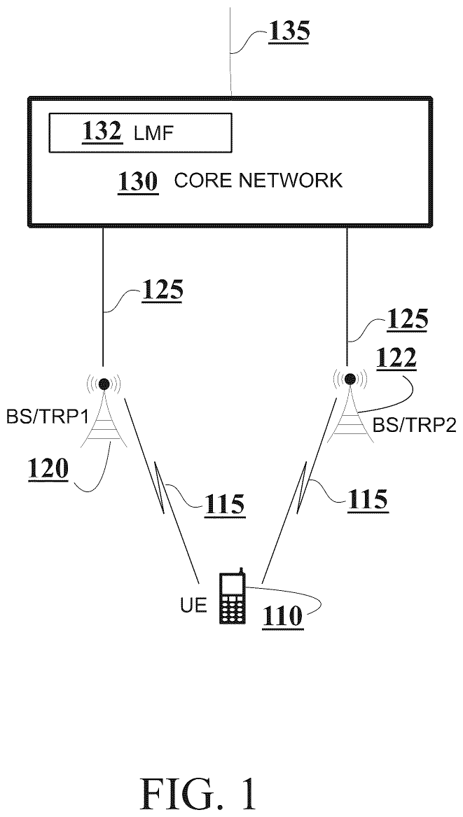

FIG. 1 illustrates an example of a network scenario in accordance with at least some example embodiments. According to the example scenario of FIG. 1, there may be a network scenario comprising UE 110, first wireless network node 120, second wireless network node 122, core network 130 and Location Management Function, LMF 132. First wireless network node 120 may be a serving Base Station, BS, or a serving Transmission and Reception Point, TRP. Second wireless network node 120 may be a neighbour BS or a neighbour TRP. UE 110 may be connected to, and communicate with, first wireless network node 120 via air interface 115. In some example embodiments, UE 110 may communicate with second wireless network node 122 via interface 115 as well.

UE 110 may comprise, for example, a smartphone, a cellular phone, a Machine-to-Machine, M2M, node, Machine-Type Communications, MTC, node, an Internet of Things, IoT, node, a Reduced Capability, RedCap, node, a car telemetry unit, a laptop computer, a tablet computer, a terrestrial/maritime/aerial vehicle, or, indeed, any kind of suitable wireless terminal.

LMF 132 may be a network entity that configures some or all control information and allocates at least some resources for UE 110. FIG. 1 illustrates a scenario, wherein wireless network nodes 120 and 122, such as TRPs, are non-co-located, i.e., in different physical devices. In some example embodiments, wireless network nodes 120 and 122 may be co-located. In case of co-located TRPs, wireless network nodes 120 and 122 may be in the same physical device and share some common functions/circuitries. That is, in case of co-located TRPs, two antenna panels may be provisioned to generate co-located TRPs 120 and 122.

Air interface 115 between UE 110 and wireless network nodes 120, 122 may be configured in accordance with a RAT, which UE 110 and wireless network nodes 120, 122 are configured to support. Examples of cellular RATs include Long Term Evolution, LTE, which may also be known as fourth generation, 4G, New Radio, NR, which may also be known as fifth generation, 5G, radio access technology, 6G, and MulteFire. A cellular RAT may be standardized by a 3rd Generation Partnership Project, 3GPP, for example. In the context of NR, wireless network nodes 120 and 122 may be referred to as gNBs while in the context of LTE, wireless network nodes 120 and 122 may be referred to as eNBs. In any case, example embodiments of the present disclosure are not restricted to any particular wireless technology. Instead, example embodiments may be exploited in any wireless communication system, wherein reference signals are transmitted based on a configuration.

Wireless network nodes 120, 122 may be connected, directly or via at least one intermediate node, with core network 130 via wired interface 125. Core network 130 may be, in turn, coupled via interface 135 with another network (not shown in FIG. 1), via which connectivity to further networks may be obtained, for example a worldwide interconnection network.

The aim of wireless sensing technologies is to acquire information about a remote object and characteristics of the remote object, without physically contacting the remote object. For example, perception data of the remote object and its surroundings may be utilized for various analysis, to gain information about the remote object. In the context of 3GPP standardization, sensing may refer to providing sensing capabilities using an infrastructure of a cellular communication network, e.g., by using the same 5G NR infrastructure that is used for communication. Sensing information may be inferred from radio signals, like Radio Frequency, RF,-based and/or non-RF based sensors. Sensing may comprise scenarios of communication-assisted sensing in which the cellular communication network provides sensing services or sensing-assisted communication. Sensing may be used to provide sensing information related to a communication channel or environment and said sensing information may be further used to improve a communication service. For example, sensing information may be exploited for radio resource management tasks, interference mitigation, beam management, mobility, etc. At least some sensing use cases may also require that the object sensing performance and identity (e.g., an identity of UE 110) may be identified for further actions via communications, for example Detect and Avoid, DAA, selecting routes for Unmanned Aerial Vehicles, UAVs, etc. In some example embodiments, sensing may be used to find a location of a passive object and hence, to allow positioning (e.g., as a part of a native 5G communication system) and sensing to be operated in a seamless manner.

Using 5G/NR as an example, use cases and potential requirements for enhancement of a 5G/NR system may comprise providing integrated communication and sensing services addressing different target verticals and/or applications, such as autonomous/assisted driving, Vehicle-to-Infrastructure, V2X, aviation, UAVs, 3D map reconstruction, smart city/factories, public sectors, healthcare, smart home and maritime sector. Alternatively, or in addition, key performance indicators related to 5G/NR based sensing (e.g., range, motion, velocity) and performance requirements for transferring sensing related data may need to be identified. Aspects related to security, privacy, regulatory requirements and charging may need to be considered as well.

Sensing of wireless communication channels and environment may further improve the performance of communication systems. Sensing-assisted communication scenarios comprise, for example, the following:
sensing UE's location and channel environment to narrow the beam sweeping range and shorten the beam training time;
sensing UE's location, velocity, motion trajectory, and channel environment for beam prediction, and reducing the overhead of beam measurement and the delay of beam tracking;
sensing UE's property and channel environment to improve the performance of channel estimation.

For example, in 5G, positioning and/or velocity estimation may be based on downlink or uplink reference signals. In downlink, PRSs may be transmitted by wireless network nodes, such as TRPs and/or BSs, to enable the position and/or velocity estimation. In uplink, SRSs may be transmitted by UEs, to enable the position and/or velocity estimation.

In case of downlink reference signals, positioning may be UE-based or UE-assisted. In the former case, a UE may determine its own position, with locations of wireless network nodes being transferred by an LMF to the UE. In the latter case, a location of the UE may be determined by the LMF, with auxiliary UE measurements being signalled to the LMF. Wireless network nodes may transmit PRS waveforms. Upon reception, UEs may use the received samples together with the transmitted samples, which may be assumed to be known and replicated by the UE, to localize itself. By processing the transmitted and received samples, the UE may estimate its own position and/or velocity, or the position and/or velocity of a target (another UE, or a passive target in the environment).

In case of uplink, wireless network nodes may use the received samples together with the transmitted samples, which may be assumed to be known, for positioning and/or velocity estimation. The UE may then be localized (positioning mode) or other targets in the environment sensed (bi-static UL sensing mode), by the LMF. Alternatively, or in addition, a wireless network node may determine (infer) the ranges and velocities of the targets (e.g., UEs and other passive targets in the environment), by processing the transmitted and received samples.

Velocity estimation may be especially useful in various use cases, such as automotive industry, Autonomous Guided Vehicles, AGVs, in factories, and UAVs. Sequential position estimates may be used for velocity estimation. However, such methodology may lead to poor velocity estimation due to propagation errors in position estimation. A more reliable approach may be to utilize the transmitted and received signals directly for velocity estimation, i.e., by measuring the Doppler shift. Although using a waveform of a reference signal to be used for positioning, such as a PRS or an SRS, with uniform power allocation may be beneficial for detecting and estimating the ranges of the UEs (positioning), such a waveform would be unsuitable for velocity estimation due to increased side-lobes of the velocity profile of the waveform. This may be especially problematic in multi-path scenarios where different signal propagation paths may significantly deteriorate the estimation procedure.

Embodiments of the present disclosure therefore provide improved velocity detection and estimation, which may be performed by appropriately scaling resource blocks, such as PRBs comprising the reference signal(s). A set of inner resource blocks may be power-muted at a centre of the frequency band while increasing the power-boosting of a set of resource blocks at the edges of the frequency band. The transmit power of the modified reference waveform may be kept the same as that of the waveform without power-muting/boosting and thus, the improvement in velocity estimation and detection may be solely due to the power-muting of the resource blocks as well as the power-boosting (via power reallocation) of the edge PRBs.

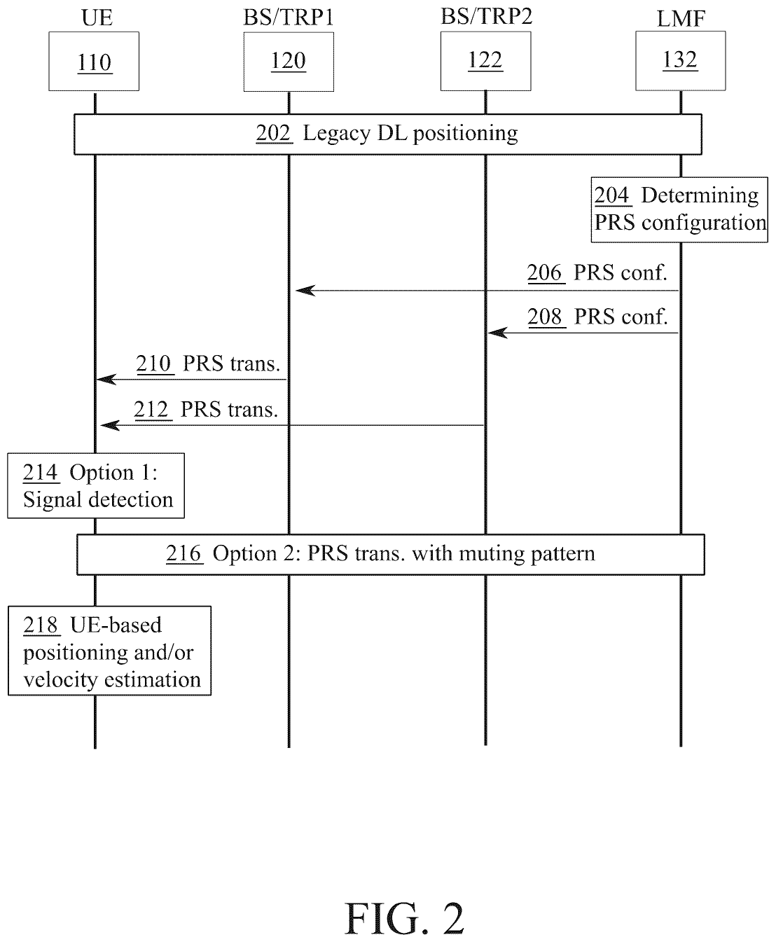

FIG. 2 illustrates a first signalling graph in accordance with at least some example embodiments. FIG. 2 illustrates signalling for positioning and/or velocity estimation based on downlink reference signals, such as PRSs. On the vertical axes are disposed, from the left to the right, UE 110, first wireless network node 120, second wireless network node 122 and LMF 132 of FIG. 1. Time advances from the top towards the bottom.

At step 202, downlink positioning may be performed using a legacy approach (UE capability, LTE Positioning Protocol, LPP, NR Positioning Protocol A, NRPPa). At step 204, LMF 132 may determine a reference signal configuration for at least one reference signal, such as a PRS, to be received by UE 110 at least from wireless network node 120, for positioning and/or velocity estimation of UE 110. The reference signal configuration may indicate a power-muting of at least one inner resource block of a plurality of resource blocks assigned by LMF 132 in the frequency-domain to the at least one reference signal, and a power-boosting of at least two edge resource blocks of the plurality of resource blocks.

The power-muting indicated in the reference signal configuration may comprise full muting or partial muting of the at least one inner resource block. In case of full muting, each of the at least one inner resource block may be nulled, i.e., the power may be set to zero. In case of partial muting, a power backoff may be used, i.e., the power of each of the at least one inner resource block may be decreased but not set to zero. In some example embodiments, the power backoff of some inner resource blocks may be different compared to the power backoff of other inner resource blocks. The power-boosting may comprise increasing the power of each of the at least two edge resource blocks, possibly in proportion to the power-muting of the inner resource blocks so as to preserve the overall transmission power.

The number of inner and edge resource blocks may be calculated based on a required trade-off accuracy between range/position and velocity detection. Increasing the number of muted resource blocks (i.e., decreasing the number of edge resource blocks) decreases the side-lobes of the velocity profile while increasing the side-lobes of the range-profile, thereby improving velocity detection and estimation at the cost of reducing the performance of range/position estimates.

At steps 206 and 208, LMF 132 may transmit the reference signal configuration to first wireless network node 120 and second wireless network node 122, respectively. LMF 132 may for example indicate the number of inner and/or edge PRBs, along with the power-muting for the inner PRBs and/or the power-boosting for the edge PRBs via NRPPa. A reference signal waveform may then be generated at wireless network nodes 120 and 122 based on the positioning requirements.

At steps 210 and 212, first wireless network node 120 and second wireless network node 122 may transmit the at least one reference signal to UE 110, respectively. The at least one reference signal may be transmitted according to the reference signal configuration.

UE 110 may have two options to reconstruct the transmitted reference signal waveform. First option may be that UE 110 uses, at step 214, a signal energy detector to determine the number of edge and inner resource blocks, which may be subsequently used to determine the power boosting, assuming the total transmitted power is preserved. That is, UE 110 may determine the reference signal configuration based on the at least one received reference signal. The power-boosting information may be utilized to reconstruct the transmitted reference signal waveform locally at UE 110. Second option may be that LMF 132 indicates, at step 216, the number of edge and/or inner resource blocks, their locations, and the power muting and/or boosting parameters to UE 110. That is, UE 110 may receive the reference signal configuration from first wireless network node 120. With the second option, UE 110 may save power resources, when compared to the first option, at the cost of additional signalling.

After step 214 or step 216, UE 110 may determine a number of the at least one inner resource block, a number of the at least two edge resource blocks, and further determine the power-boosting for the at least two edge resource blocks based on the number of the at least one inner resource block, the number of the at least two edge resource blocks and the amount of power-muting for the at least one inner resource block. In some example embodiments, the power-boosting may be calculated for the overall transmission power to remain the same (i.e. overall transmission power is preserved).

At step 218, UE 110 may estimate its position and/or velocity based on the at least one reference signal. For example, UE 110 may use the reconstructed transmitted reference signal waveform and received waveform to perform UE-based positioning or radar processing to obtain the range-velocity map corresponding to UE 110 or to targets of the environment. UE 110 may then report information on its own position and velocity, or information on position and velocity of a detected target, back to LMF 132.

Depending on the information received from UE 110, LMF 132 may choose to modify the number of inner and/or edge resource blocks, and/or the power boosting, depending on the required trade-off between position and velocity estimation. Then, the process may be repeated. For example, if the velocities of the targets are detected quite well, LMF 132 may decrease the number of inner resource blocks and/or decrease the muting/boosting to get the reference signal spectrum as flat as possible to also detect the ranges of the targets, thereby helping in tracking a target with a specific velocity.

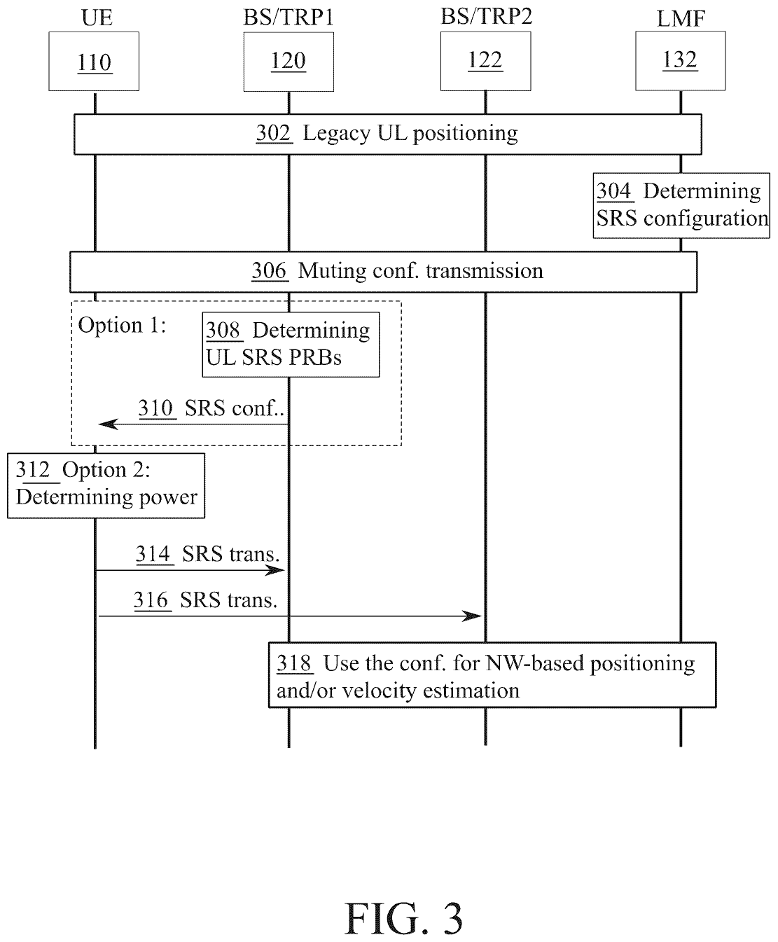

FIG. 3 illustrates a second signalling graph in accordance with at least some example embodiments. FIG. 3 illustrates signalling for uplink reference signals, such as SRS. On the vertical axes are disposed, from the left to the right, UE 110, first wireless network node 120, second wireless network node 122 and LMF 132 of FIG. 1. Time advances from the top towards the bottom.

At step 302, uplink positioning may be performed using a legacy approach (UE capability, LPP, NRPPa). At step 304, LMF 132 may determine a reference signal configuration for at least one reference signal, such as an SRS to be transmitted by UE 110, for positioning and/or velocity estimation of UE 110. The reference signal configuration may indicate a power-muting of at least one inner resource block of a plurality of resource blocks assigned in the frequency-domain to the at least one reference signal, and/or a power-boosting of at least two edge resource blocks of the plurality of resource blocks. The number of inner and edge resource blocks may be calculated in the same way as at step 204 of FIG. 2.

At step 306, LMF 132 may transmit the reference signal configuration to UE 110, first wireless network node 120 and/or second wireless network node 122. LMF 132 may indicate the number of inner and/or edge PRBs, along with the power-muting parameters for the inner PRBs and/or the power-boosting parameters for the edge PRBs to first wireless network node 120 and second wireless network node 122 via NRPPa. LMF 132 may indicate the number of inner and/or edge PRBs, along with the power-muting and/or boosting parameters to UE 110 through LPP.

There may be two options for determining the power boosting of the edge PRBs. First option may be that first wireless network node 120 determines, at step 308, the power muting/boosting based on the reference signal configuration received from LMF 132. First wireless network node 120 may then, at step 310, transmit the reference signal configuration to UE 110. UE 110 may hence receive the reference signal configuration from first wireless network node 120 and transmit the at least one reference signal according to the received reference signal configuration.

Second option may be that UE 110 determines, at step 312, the power-muting for the inner PRBs and/or the power boosting for the edge PRBs based on the reference signal configuration received by LMF 132, and possibly based on its own capability as well. For example, first wireless network node 120 may transmit a muting/boosting pattern to UE 110 and UE 110 may determine the reference signal configuration based on the muting/boosting pattern. UE 110 may then transmit the at least one reference signal according to the determined reference signal configuration. The muting pattern may comprise a binary string with one bit per resource block or a group of resource blocks, such as ‘1’ value=power muting/nulling of the corresponding resource block or a group of resource blocks; ‘0’ value=no power muting/nulling of the corresponding resource block or a group of resource blocks. For example, if the reference signal comprises 12 resource blocks and there are 4 inner resource blocks to be muted, then the muting pattern may be “000011110000”. Alternatively, first wireless network node 120 may transmit a boosting pattern to UE 110 and UE 110 may determine the reference signal configuration based on the boosting pattern. Still for example, if the reference signal comprises 12 resource blocks and there are 4 edge resource blocks to be boosted, then the boosting pattern may be “110000000011”.

At steps 314 and 316, UE 110 may transmit the at least one reference signal to wireless network node 120 and 122, respectively. At step 318, network-based position and/or velocity estimation may be performed based on the at least one reference signal. For example, LMF 132 may perform network-based positioning or radar processing to obtain the range-velocity map corresponding to UE 110 or to a target of the environment, based on information received from first wireless network node 120 and second wireless network node 122. LMF 132 may then perform the same actions as in case of the example of FIG. 2.

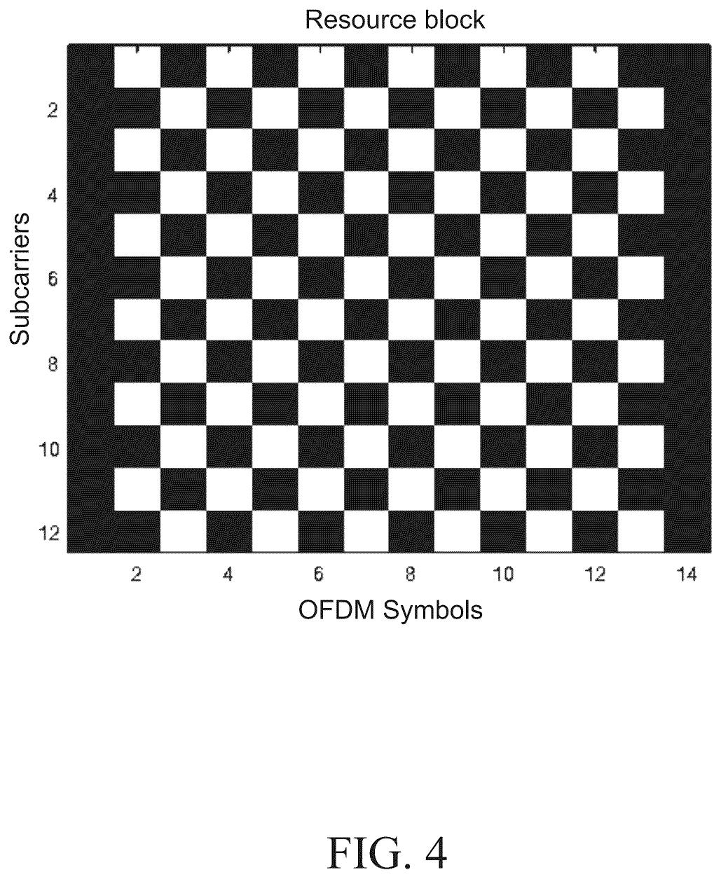

FIG. 4 illustrates a resource block in accordance with at least some example embodiments. The illustrated resource block may be a resource block of a reference signal, such as a PRS or an SRS. The transmitted frequency-domain symbols of the resource block may be modified in accordance with embodiments of the present disclosure. The resource block may have a comb size of 2 and 12 Orthogonal Frequency-Division Multiplexed, OFDM, symbols may be used.

Depending on the required range/position and velocity resolutions, the total number of subcarriers and OFDM symbols may be defined, which may result in multiple resource blocks for a reference signal transmission. Muting is applied in the frequency domain such that the inner resource blocks are muted/empty. The frequency-domain muting may be exploited to provide a better estimate of a velocity of UE 110 or of a velocity of a target.

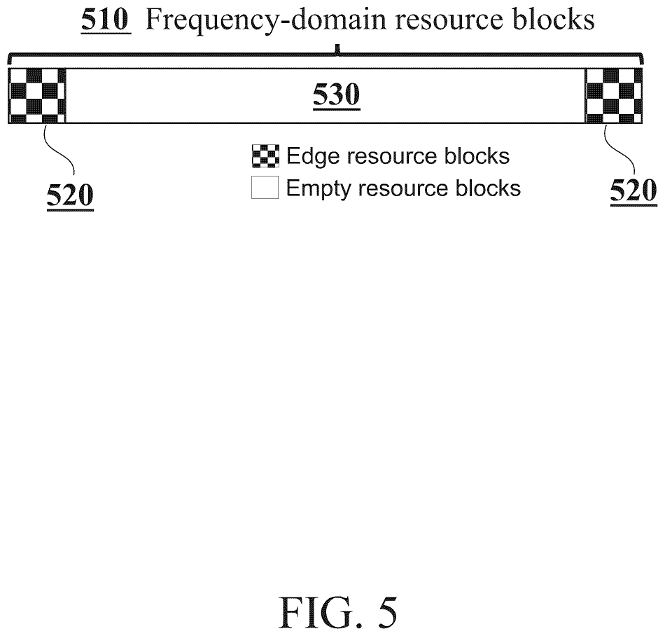

FIG. 5 illustrates frequency muting in accordance with at least some example embodiments. In FIG. 5, the entire set of resource blocks, such as PRBs, in frequency domain is denoted by 510, edge resource blocks are denoted by 520 and inner resource blocks are denoted by 530.

Inner resource blocks 530 may be partially or wholly muted. The available total transmit power may be shared equally between the two sets of edge resource blocks 520. Hence, when compared to reference signals which have uniform power allocation along all the resource blocks, edge resource blocks 520 have a higher power at the edges of the allocated bandwidth, while inner resource blocks 530 at the centrum of the allocated bandwidth have a lower power or do not have any power at all. Inner resource blocks 530 may be nulled while edge resource blocks 520 may be scaled appropriately by a real-valued number. Hence, the power-boosting allocation is practical to implement.

As illustrated in FIG. 5, at least one inner resource block 530 may be between a first set of edge resource blocks 520 (e.g., on the left) and a second set of edge resource blocks 520 (e.g., on the right). In such a case, at least one inner resource block 530 may be referred to as a centre resource block. Muting/nulling and power-boosting may hence be symmetric.

Alternatively, asymmetric muting/nulling and power-boosting may be used. For example, the muting pattern may be “0000 0011 1100” with 12 resource blocks. The transmit power may be re-allocated to some pre-defined/configured number of edge resource blocks 520 as for the symmetrical case.

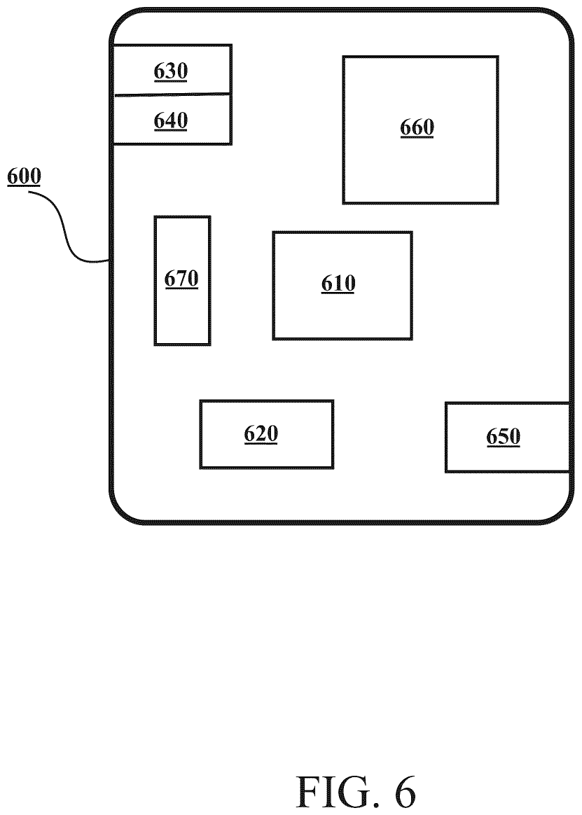

FIG. 6 illustrates an example apparatus capable of supporting at least some example embodiments. Illustrated is device 600, which may comprise or be comprised in, for example, UE 110 or LMF 132. Comprised in device 600 is processor 610, which may comprise, for example, a single- or multi-core processor wherein a single-core processor comprises one processing core and a multi-core processor comprises more than one processing core. Processor 610 may comprise, in general, a control device. Processor 610 may comprise more than one processor. Processor 610 may be a control device. Processor 610 may comprise at least one Application-Specific Integrated Circuit, ASIC. Processor 610 may comprise at least one Field-Programmable Gate Array, FPGA. Processor 610 may comprise at least one Qualcomm Snapdragon and/or Intel Atom processor. Processor 610 may comprise, for example, a Cortex-A8 processing core manufactured by ARM Holdings or a Steamroller processing core produced by Advanced Micro Devices Corporation. Processor 610 may be means for performing method steps in device 600, such as determining, causing transmitting and causing receiving. Processor 610 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a network function, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 600 may comprise memory 620. Memory 620 may comprise random-access memory and/or permanent memory. Memory 620 may comprise at least one RAM chip. Memory 620 may comprise solid-state, magnetic, optical and/or holographic memory, for example. Memory 620 may be at least in part accessible to processor 610. Memory 620 may be at least in part comprised in processor 610. Memory 620 may be means for storing information. Memory 620 may comprise computer instructions that processor 610 is configured to execute. When computer instructions configured to cause processor 610 to perform certain actions are stored in memory 620, and device 600 overall is configured to run under the direction of processor 610 using computer instructions from memory 620, processor 610 and/or its at least one processing core may be considered to be configured to perform said certain actions. Memory 620 may be at least in part comprised in processor 610. Memory 620 may be at least in part external to device 600 but accessible to device 600.

Device 600 may comprise a transmitter 630. Device 600 may comprise a receiver 440. Transmitter 630 and receiver 640 may be configured to transmit and receive, respectively, information in accordance with at least one cellular or non-cellular standard. Transmitter 630 may comprise more than one transmitter. Receiver 640 may comprise more than one receiver. Transmitter 630 and/or receiver 640 may be configured to operate in accordance with Global System for Mobile communication, GSM, Wideband Code Division Multiple Access, WCDMA, Long Term Evolution, LTE, and/or 5G/NR standards, for example.

Device 600 may comprise a Near-Field Communication, NFC, transceiver 650. NFC transceiver 650 may support at least one NFC technology, such as Bluetooth, Wibree or similar technologies.

Device 600 may comprise User Interface, UI, 660. UI 660 may comprise at least one of a display, a keyboard, a touchscreen, a vibrator arranged to signal to a user by causing device 600 to vibrate, a speaker and a microphone. A user may be able to operate device 600 via UI 660, for example to accept incoming telephone calls, to originate telephone calls or video calls, to browse the Internet, to manage digital files stored in memory 620 or on a cloud accessible via transmitter 630 and receiver 640, or via NFC transceiver 650, and/or to play games.

Device 600 may comprise or be arranged to accept a user identity module 670. User identity module 670 may comprise, for example, a Subscriber Identity Module, SIM, card installable in device 600. A user identity module 670 may comprise information identifying a subscription of a user of device 600. A user identity module 670 may comprise cryptographic information usable to verify the identity of a user of device 600 and/or to facilitate encryption of communicated information and billing of the user of device 600 for communication effected via device 600.

Processor 610 may be furnished with a transmitter arranged to output information from processor 610, via electrical leads internal to device 600, to other devices comprised in device 600. Such a transmitter may comprise a serial bus transmitter arranged to, for example, output information via at least one electrical lead to memory 620 for storage therein. Alternatively to a serial bus, the transmitter may comprise a parallel bus transmitter. Likewise processor 610 may comprise a receiver arranged to receive information in processor 610, via electrical leads internal to device 600, from other devices comprised in device 600. Such a receiver may comprise a serial bus receiver arranged to, for example, receive information via at least one electrical lead from receiver 640 for processing in processor 610. Alternatively to a serial bus, the receiver may comprise a parallel bus receiver.

Device 600 may comprise further devices not illustrated in FIG. 6. For example, where device 600 comprises a smartphone, it may comprise at least one digital camera. Some devices 600 may comprise a back-facing camera or a front-facing camera, wherein the back-facing camera may be intended for digital photography and the front-facing camera for video telephony. Device 600 may comprise a fingerprint sensor arranged to authenticate, at least in part, a user of device 600. In some embodiments, device 600 lacks at least one device described above. For example, some devices 600 may lack a NFC transceiver 650 and/or user identity module 670.

Processor 610, memory 620, transmitter 630, receiver 640, NFC transceiver 650, UI 660 and/or user identity module 670 may be interconnected by electrical leads internal to device 600 in a multitude of different ways. For example, each of the aforementioned devices may be separately connected to a master bus internal to device 600, to allow for the devices to exchange information. However, as the skilled person will appreciate, this is only one example and depending on the embodiment various ways of interconnecting at least two of the aforementioned devices may be selected without departing from the scope of the embodiments.

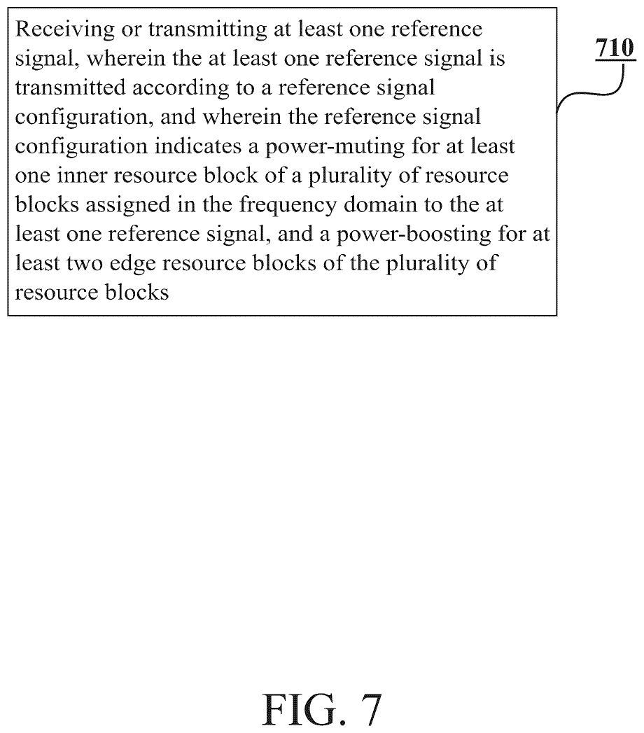

FIG. 7 is a flow graph of a first method in accordance with at least some example embodiments. The phases of the illustrated first method may be performed by UE 110.

The first method may comprise, at step 710, receiving or transmitting at least one reference signal, wherein the at least one reference signal is transmitted according to a reference signal configuration, and wherein the reference signal configuration indicates a power-muting for at least one inner resource block of a plurality of resource blocks assigned in the frequency-domain to the at least one reference signal, and a power-boosting for at least two edge resource blocks of the plurality of resource blocks.

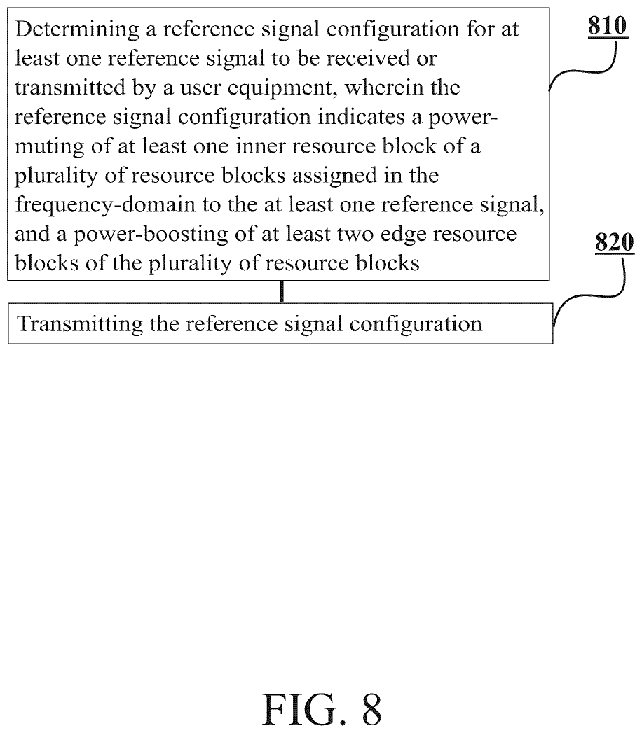

FIG. 8 is a flow graph of a second method in accordance with at least some example embodiments. The phases of the illustrated second method may be performed by LMF 132.

The second method may comprise, at step 810, determining a reference signal configuration for at least one reference signal to be received or transmitted by a user equipment, wherein the reference signal configuration indicates a power-muting of at least one inner resource block of a plurality of resource blocks assigned in the frequency-domain to the at least one reference signal, and a power-boosting of at least two edge resource blocks of the plurality of resource blocks. The second method may also comprise, at step 820, transmitting the reference signal configuration.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, comprising for example UE 110 or LMF 132, may further comprise means for carrying out the example embodiments described above and any combination thereof. The apparatus may be an apparatus of a cellular communication network, such as a 5G network, and comprise means for operating in the cellular communication network.

In an example embodiment, a computer program comprising instructions which, when the program is executed by a computer, cause the computer to carry out a method in accordance with the example embodiments described above and any combination thereof. In an example embodiment, a computer program product, embodied on a non-transitory computer readable medium, may be configured to control a processor to perform a process comprising the example embodiments described above and any combination thereof. The term “non-transitory,” as used herein, is a limitation of the medium itself (i.e., tangible, not a signal) as opposed to a limitation on data storage persistency (e.g., RAM vs. ROM).

In an example embodiment, an apparatus, comprising for example UE 110 or LMF 132, may further comprise at least one processor and at least one memory storing instructions that, when executed by the at least one processor, cause the apparatus at least to perform the example embodiments described above and any combination thereof. The apparatus may be an apparatus of a cellular communication network, such as a 5G network, and configured to operate in the cellular communication network.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the example embodiments in one or more particular applications, it will be apparent to those of ordinary skill in the art that numerous modifications in form, usage and details of implementation may be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, that is, a singular form, throughout this document does not exclude a plurality. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

### INDUSTRIAL APPLICABILITY

At least some example embodiments find industrial application in cellular communication networks, such as 5G networks, and possibly in other cellular communication networks in the future as well.

ACRONYMS LIST

| | |
|---|---|
| 3GPP | 3rd Generation Partnership Project |
| AGV | Autonomous Guided Vehicles |
| BS | Base Station |
| DAA | Detect and Avoid |
| GSM | Global System for Mobile communication |
| IoT | Internet of Things |
| LMF | Location Management Function |
| LPP | LTE Positioning Protocol |
| LTE | Long-Term Evolution |
| M2M | Machine-to-Machine |
| MAC | Medium Access Control |
| MTC | Machine-Type Communications |
| NFC | Near-Field Communication |
| NR | New Radio |
| NRPPa | NR Positioning Protocol A |
| OFDM | Orthogonal Frequency-Division Multiplexed |
| PRS | Positioning Reference Signal |
| RAT | Radio Access Technology |
| RF | Radio Frequency |
| SRS | Sounding Reference Signal |
| TRP | Transmission and Reception Point |
| UAV | Unmanned Aerial Vehicle |
| UE | User Equipment |
| UI | User Interface |
| V2X | Vehicle-to-Infrastructure |
| WCDMA | Wideband Code Division Multiple Access |
| WiMAX | Worldwide Interoperability for Microwave Access |
| WLAN | Wireless Local Area Network |

REFERENCE SIGNS LIST

| | |
|---|---|
| 110 | UE |
| 115 | Air interfaces |
| 120, 122 | Wireless network nodes |
| 125, 135 | Wired interfaces |
| 130 | Core network |
| 202-218 | Steps in the signalling graph of FIG. 2 |
| 302-318 | Steps in the signalling graph of FIG. 3 |
| 510 | Set of resource blocks |
| 520 | Edge resource blocks |
| 530 | Inner resource blocks |
| 600-670 | Structure of the apparatus of FIG. 6 |
| 710 | Phases of the method in FIG. 7 |
| 810-820 | Phases of the method in FIG. 8 |

1. An apparatus, comprising:
at least one processor; and
at least one memory storing instructions that, when executed by the at least one processor, cause the apparatus at least to:
receive or transmit at least one reference signal, wherein the at least one reference signal is transmitted according to a reference signal configuration, and wherein the reference signal configuration indicates a power-muting for at least one inner resource block of a plurality of resource blocks assigned in the frequency-domain to the at least one reference signal, and a power-boosting for at least two edge resource blocks of the plurality of resource blocks.

2-15. (canceled)
